(19) United States
(12) Patent Application Publication
(10) Pub. No.: US 2021/0252877 A1
(43) Pub. Date: Aug. 19, 2021

(54) METHOD AND APPARATUS FOR SUPPORTING AND HEATING A RECORDING MEDIA WITHOUT PHYSICAL CONTACT

(71) Applicant: Palo Alto Research Center, Palo Alto, CA (US)

(72) Inventor: David K. BIEGELSEN, Portola Valley, CA (US)

(21) Appl. No.: 16/790,208

(22) Filed: Feb. 13, 2020

(51) Int. Cl. B41J 11/00; G03D 13/00; B41M 5/00

(52) U.S. Cl. CPC B41J 11/002; B41M 5/0011; G03D 13/002

(57) ABSTRACT

According to aspects of the embodiments, there is provided process and apparatus using an in-line air bearing heater to maintain ambient elevated temperature or to provide extra heating to a recording media moving along a path in an imaging system. The heated air bearing is also useful for shearing the surface of molten toner or inks to level and gloss an image at the recording media.

### BACKGROUND OF THE INVENTION

This disclosure relates generally to a drying apparatus configured to dry droplets adhering to a recording medium without physical contact, and more particularly, to such process for supporting a web in a heated and/or moist environment when physical contact would be detrimental to a web coating or the web itself.

### BACKGROUND

Conventional examples of such an apparatus include an inkjet printing apparatus. The inkjet printing apparatus includes inkjet heads (printhead) configured to discharge ink droplets to a print medium (e.g., web paper), a mechanism configured to move the printhead and the print medium relatively, and a drying unit configured to dry the ink droplets adhering to the print medium. In another type of inkjet printing apparatus, phase change inks are used. Phase change inks remain in the solid phase at ambient temperature, but transition to a liquid phase at an elevated temperature. The printhead unit ejects molten ink supplied to the unit onto media or an imaging member.

Conventional drying units include one having a heat drum (also referred to as a heating roller) with a heater embedded therein. A back face of the print medium contacts the heat drum, and is wound on the heat drum. Accordingly, when the print medium passes while being wound on the heat drum, the ink droplets adhering to the print medium is dried with heat from the heat drum.

However, the transporting and heating causes molten coating, such as ink, to flow or diffuse on to non-applied areas of the imaging media and on to the transport mechanism leading to build up or freezing of molten coating. For these reasons there is a need in the art to transport a recording media with surface coating (material) without physically contact when the media is at elevated temperatures.

### SUMMARY

According to aspects of the embodiments, there is provided process and apparatus using an in-line air bearing heater to maintain ambient elevated temperature or to provide extra heating to a recording medium moving along a path in an imaging system. The heated air bearing is also useful for shearing the surface of molten toner or inks to level and gloss an image at the recording medium.

### BRIEF DESCRIPTION OF THE DRAWINGS

Various exemplary embodiments of the disclosed apparatuses, mechanisms and methods will be described, in detail, with reference to the following drawings, in which like referenced numerals designate similar or identical elements, and:

FIG. 1 is a schematic diagram of an inkjet printing system with an in-line air bearing heater in accordance with an example of the embodiments;

FIG. 2 is a schematic diagram of another embodiment of an inkjet printer with an in-line air bearing heater in accordance to an embodiment;

FIG. 3 shows a partial view of an in-line air bearing heater in accordance to an embodiment;

FIG. 4 illustrates a single an in-line air bearing heater and convection oven useful for transporting and contactless heating of a recording media in accordance to an embodiment; and,

FIG. 5 is a flowchart depicting the operation of an in-line air bearing heater accordance to an environment.

### DETAILED DESCRIPTION

Illustrative examples of the devices, systems, and methods disclosed herein are provided below. An embodiment of the devices, systems, and methods may include any one or more, and any combination of, the examples described below. This invention may, however, be embodied in many different forms and should not be construed as limited to the embodiments set forth below. Rather, these exemplary embodiments are provided so that this disclosure will be thorough and complete, and will fully convey the scope of the invention to those skilled in the art. Accordingly, the exemplary embodiments are intended to cover all alternatives, modifications, and equivalents as may be included within the spirit and scope of the apparatuses, mechanisms and methods as described herein.

In one aspect, an apparatus useful in processing a recording medium moving along a path in an imaging system, comprising a print zone including a first plurality of marking material deposition sources configured to facilitate surface coatings on a side of the recording medium; a blower configured to provide a flow of pressurized air; at least one turnbar with at least one aperture disposed thereon to provide, from the flow of pressurized air, an air bearing having a leading edge and a trailing edge; wherein the turnbar defines a first tangent line corresponding to an initial point of interaction of the recording medium and the turnbar, a second tangent line corresponding to a last point of contact of the recording media with the turnbar, and a contacting area disposed between the first tangent line and the second tangent line; wherein the turnbar having an exterior surface defining a first region and a second region, which is substantially devoid of apertures, the first region having the at least one aperture operatively connected to the blower, the at least one aperture defining a pattern aligned in a longitudinal direction along a length of the turnbar, the at least one aperture being configured to direct the pressurized air from the exterior surface of the turnbar, and the pressurized air through the second region is not directed from the exterior surface.

In another aspect, the pressurized air is selected from the group consisting of heated air, gas, vapor, superheated steam, and combination thereof.

In another aspect the exterior surface can be rotating.

In yet another aspect, heat from the pressurized air can be transferred to the recording media to raise the temperature of the recording media, to facilitate drying, or to facilitate leveling of the surface coatings.

In still another aspect, the at least one aperture comprises a plurality of apertures selected from the group consisting of holes, slots, slits, and combinations thereof; and wherein the plurality of apertures defining a pattern including a plurality of rows and a plurality of columns, each of the rows being aligned in a longitudinal direction along a length of the turnbar, one of a first row of apertures and a last row of apertures being disposed outside of the contacting area.

In yet another aspect, the plurality of columns includes a first column and a last column and at least one of the plurality of columns is disposed outside of the contacting area; and wherein the at least one turnbar is a cylinder made from a material selected from the group consisting of metal, aluminum, plastic having melting point higher than 200° C., and combinations thereof.

In another aspect, the apparatus further comprising a heater to direct heat onto a portion of the at least one turnbar to heat the pressurized air.

In a further aspect, the flow of pressurized air prevents the recording media from contacting the at least one turnbar at the exterior surface defining a first region; and wherein the recording media is a web of material.

In still yet a further aspect, a method for heating a recording media moving along a path in an imaging system, comprising applying surface coatings on a side of the recording media; providing a flow of pressurized air; providing at least one turnbar with at least one aperture disposed thereon to provide, from the flow of pressurized air, an airfoil having a leading edge and a trailing edge; wherein the turnbar defines a first tangent line corresponding to an initial point of contact of the recording media and the turnbar, a second tangent line corresponding to a last point of contact of the recording media with the turnbar, and a contacting area disposed between the first tangent line and the second tangent line; wherein the turnbar having an exterior surface defining a first region and a second region, which is substantially devoid of apertures, the first region having the at least one aperture operatively connected to a blower, the at least one aperture defining a pattern aligned in a longitudinal direction along a length of the turnbar, the at least one aperture being configured to direct the pressurized air from the exterior surface of the turnbar, and the pressurized air through the second region is not directed from the exterior surface; moving the recording media along a substantially curved path, wherein the substantially curved path is adjacent to the first region of the at least one turnbar; bending the recording media as it is moves along the substantially curved path and preventing by application of the pressurized air the recording media from contacting the first curved surface.

It is initially pointed out that description of well-known starting materials, processing techniques, components, equipment and other well-known details may merely be summarized or are omitted so as not to unnecessarily obscure the details of the present disclosure. Thus, where details are otherwise well known, we leave it to the application of the present disclosure to suggest or dictate choices relating to those details. The drawings depict various examples related to embodiments of illustrative methods, apparatus, and systems for printing and using an in-line air bearing heater after application of surface coatings on a recording media.

When referring to any numerical range of values herein, such ranges are understood to include each and every number and/or fraction between the stated range minimum and maximum. For example, a range of 0.5-6% would expressly include the endpoints 0.5% and 6%, plus all intermediate values of 0.6%, 0.7%, and 0.9%, all the way up to and including 5.95%, 5.97%, and 5.99%. The same applies to each other numerical property and/or elemental range set forth herein, unless the context clearly dictates otherwise.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.”

The terms “media”, “web”, “web substrate”, “recording media”, “print substrate” and “substrate sheet” generally refers to a usually flexible physical sheet of paper, polymer, Mylar material, plastic, or other suitable physical print media substrate, sheets, webs, etc., for images, whether precut or web fed. The listed terms “recording media”, “media”, “print media”, “print substrate” and “print sheet” may also include woven fabrics, non-woven fabrics, metal films, carbon fiber reinforced material and foils, as readily understood by a skilled artisan.

The term “surface coating” or “marking material” as used herein may refer to printing matter deposited by an image forming device onto a web substrate to form an image on the substrate. The listed term “surface coating” or marking material and the like may include inks, toners, metal particles, plastics, pigments, powders, molten materials, polyamide, nylon, glass filled polyamide, epoxy resins, bio-based resins, wax, graphite, graphene, carbon fiber, photopolymers, polycarbonate, polyethylene, Polylactic acid (PLA), Polyvinyl alcohol (PVA), ABS filament, high-density polyethylene (HDPE), high impact polystyrene (HIPS), Polyethylene terephthalate (PETT), ceramics, conductive filament and other ink jet materials.

The term ‘image forming device”, “imaging system”, “printing device” or “printer” as used herein encompasses any apparatus that performs a print outputting function for any purpose, such as a digital copier, scanner, image printing machine, xerographic device, digital production press, document processing system, image reproduction machine, bookmaking machine, facsimile machine, multi-function machine, or the like and can include several marking engines, feed mechanism, scanning assembly as well as other print media processing units, such as paper feeders, finishers, and the like. An image forming device can handle sheets, webs, marking materials, and the like. An image forming device can place marks on any surface, and the like and is any machine that reads marks on input sheets; or any combination of such machines. A 3D printer can make a 3D object, and the like. It will be understood that the structures depicted in the figures may include additional features not depicted for simplicity, while depicted structures may be removed or modified.

The term “controller” is used herein generally to describe various apparatus relating to the operation of one or more device that directs or regulates a process or machine. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

The examples further include at least one machine-readable medium comprising a plurality of instructions, when executed on a computing device, to implement or perform a method as disclosed herein. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

Although embodiments of the invention are not limited in this regard, discussions utilizing terms such as, for example, “processing,” “computing,” “calculating,” “determining,” “using,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

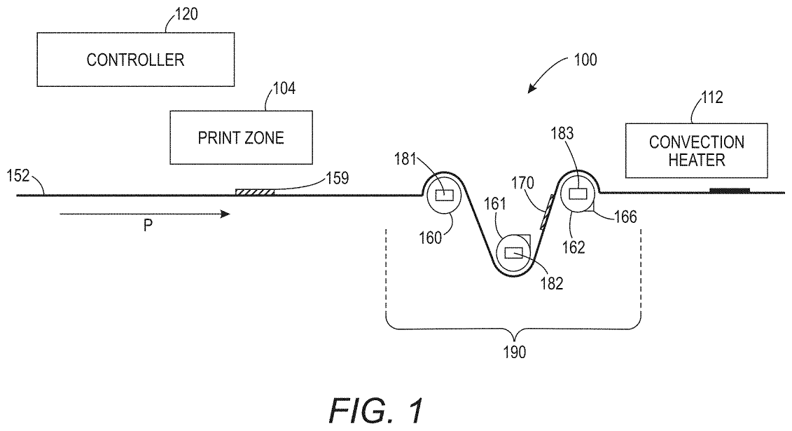

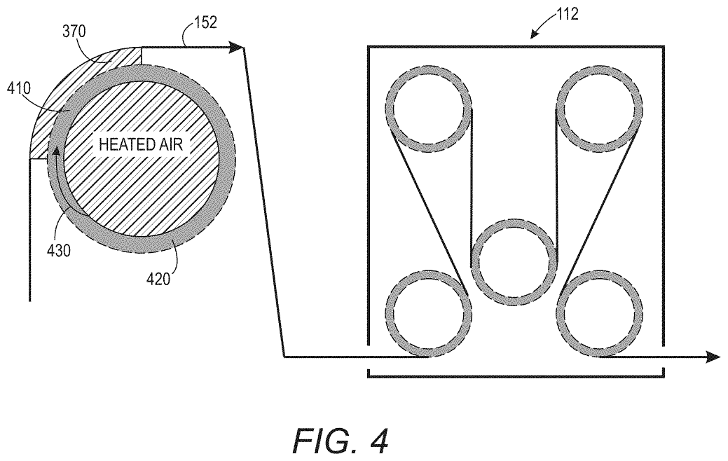

The to be described embodiments extends the known art of air-bearing turn bars at room temperature to operation with heated air, other gases or vapors such as superheated steam. As shown in FIG. 4 hollow cylinders spanning the recording media width (such as a web) are provided with air paths from the interior to outer surface. Pressurized and heated air creates an air bearing for the moving recording media such as a web. Alternatively, heated metal cylinders can be used to heat the input air directly like shown in FIG. 1. The heated air not only is used as an air bearing for supporting the web without physical contact, but the heat can be transferred to the web to raise the temperature of the web, to facilitate in drying, or to facilitate leveling of surface coatings through shear stresses between the static cylinder and moving web.

FIG. 1 is a schematic diagram of an inkjet printing system with an in-line air bearing heater. The inkjet printing system 100 forms images from a surface coating on a recording media. The system 100 includes a print zone 104 surface coating applicator, an in-line air bearing heater 190, a convection heater 112, and a digital controller 120. The print zone 104 includes at least one printhead that includes marking material deposition sources like a plurality of inkjets or other marking means. The marking material deposition sources such as inkjets emit drops of material to form predetermined printed arrangements of the material on a first side of a recording media 152. An optional second print zone, opposite print zone 104, may be included to deposit surface coatings on the opposite side of the recording media 152. A digital controller 120, such as a digital microprocessor or microcontroller, controls the operation of the printheads in the print zones 104 in addition to other components in the printer 100. In the system 100, the recording media 152 is a continuous recording media, such as an elongated roll of paper or other substrate material. In the system 100 a media transport (not shown) moves an elongated recording media 152 like a web in a process direction P past the print zone 104, through the in-line air bearing heater 190, and a two-sided convection heater 112. Typical embodiments of media transports use one or more rollers and actuators to support and move the recording media 152 in the process direction P at a predetermined velocity.

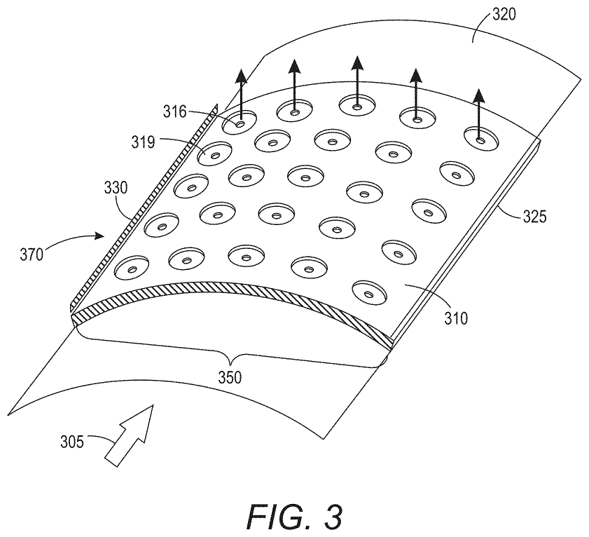

During operation, the recording media 152 moves in the process direction P through the first print zone 104 where the inkjets eject drops of surface coating like hydrophobic material to form a first predetermined arrangement 159 on a first side of the recording media 152. In other embodiments, the media transport includes a duplexing device such as a web inverter that returns the recording media to the print zone 104 for the printheads to print on the second side of the recording media. Alternatively a second in-line print zone can print on the second side of the recording media. After applying a coating the recording media is processed through an in-line air bearing heater 190 comprising a turnbar (cylinder) with a plurality of apertures. The plurality of apertures formed in the surface of a turnbar, as discussed below with reference to FIG. 3, directs a forced air from the internal cavity to the surface of the turnbar where the forced air escapes. As the recording media such as a continuous web of print media moves across the turnbar, a cushion of air is formed at the outer surface of the turnbar. The air bearing is applied to a selected portion of the media creating a lifting force away from the turnbar. The air pressure and flow rate can be controlled to provide the desired air bearing force and thickness as well as to control shear flow between roller and medium to effect drying or leveling of the deposited material. The turnbar can be static or rotating.

Referring again to FIG. 1, the in-line air bearing heater 190 comprises three porous cylinders (160,161,162) such as turnbars with apertures; the cylinders can be made of various materials such as metal like aluminum, and from materials like plastic provided it can withstand temperatures of 200 ° C., or from composites of metal and plastic provided that cylinder maintains its form in a range of temperatures like 150 to 300° C. Each turnbar or cylinder has blowers (181, 182, and 183) to fill the cylinder with air at different states and with optional heaters 166 to increase the temperature of the cylinder and air at the cylinder's inner cavity. The air passing through the apertures provides a lifting pressure to separate the recording media from the surface of the cylinder during movement P. Further, each turnbar or cylinder (160, 161,162) could be coupled to a rotation mechanism such as motor so that the cylinder could turn.

The airbearing at each of the turnbars is created by blowers (181, 182, 183) directed through the apertures of the cylinder thus providing a lifting pressure to separate the recording media 152 from the surface of the cylinder during movement (P) of the media. Each of the cylinders (160, 161, and 162) includes internal cavities which receive forced air from the blower 181, 182, 183. The lifting force provided by the cylinder apertures depends on the air pressure provided by the blower such as blowers 181,182,183, the area outer perimeter of the cylinder in contact with the media like paper, and the number, size and location of apertures formed in the surface of the cylinder through which the forced air escapes. The pressurized air out of the apertures can be in the form of heated air, gas, vapor, superheated steam, and combination thereof. The heated air not only is used as an air bearing for supporting the web without physical contact, but the heat can be transferred to the recording media to raise the temperature of the media, to facilitate in drying, or to facilitate leveling of surface coatings 170 through shear stresses between a cylinder (160, 161, 162) and print media or web 152 moving at different speeds.

Returning to FIG. 1, an optional convection heater 112 is shown to provide additional heating to the recording media 152 and surface coating 170. The convection heater 112 applies a controlled heating process to enable the coating (160, 170) formed on the recording media 152 to penetrate into the recording media in a controller manner.

While exemplary components are shown in FIG. 1, various alternative and optional components are also suitable for use with the system 100.

Next, a second embodiment of the present invention will be described. Note that portions which are the same as those in the first embodiment described above are denoted by the same reference numerals, and descriptions of the same portions as those as in the first embodiment will be omitted.

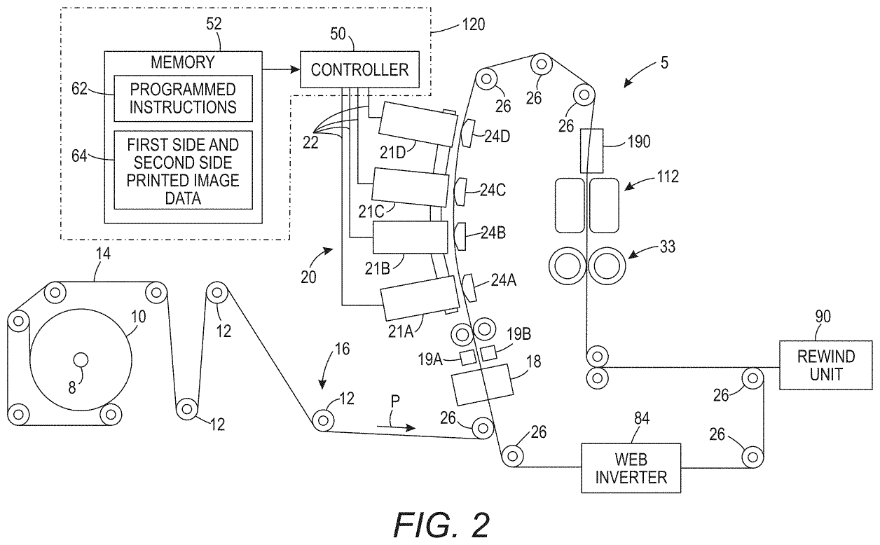

FIG. 2 is a schematic diagram of another embodiment of an inkjet printer 5 with an in-line air bearing heater 190 in accordance to an embodiment.

FIG. 2 is a simplified schematic view of the direct-to-sheet, continuous-media, phase-change inkjet printer 5, that is configured to generate printed arrangements of the material (coating 159) using a plurality of printheads positioned in a print zone in the printer. A media supply and handling system is configured to supply a long (i.e., substantially continuous) web of media 152 of “substrate” from a media source, such as a spool of media 10 mounted on a web roller 8. For simplex printing, the printer includes the web roller 8, media conditioner 16, print zone or printing station 20, and rewind unit 90. For duplex operations, the web inverter 84 is used to flip the web to present a second side of the media to the printing station 20 before being taken up by the rewind unit 90. In the simplex operation, the media source 10 has a width that substantially covers the width of the rollers 12 and 26 over which the media travels through the printer. In duplex operation, the media source has a width that is approximately one-half of the width of the rollers. Thus, the web can travel over about one-half of the length of the rollers in the printing station 20 before being flipped by the inverter 84 and laterally displaced by a distance that enables the web to travel over the other half of the length of the rollers in the printing station 20. The rewind unit 90 is configured to wind the web onto a roller for removal from the printer and subsequent processing.

The media can be unwound from the source 10 as needed and propelled by a variety of motors, not shown, rotating one or more rollers. The media conditioner includes rollers 12 and a pre-heater 18. The rollers 12 control the tension of the unwinding media as the media moves along a path through the printer. The pre-heater 18 brings the web to an initial predetermined temperature that is selected for desired image characteristics corresponding to the type of media being printed as well as the type, colors, and number of inks being used. The pre-heater 18 can use contact, radiant, conductive, or convective heat to bring the media to a target preheat temperature, which in one practical embodiment, is in a range of about 30° C. to about 70° C.

The media are transported through a printing station 20 that includes a series of color units 21A, 21B, 21C, and 21D, each color unit effectively extending across the width of the media and being able to place a marking agent directly (i.e., without use of an intermediate or offset member) onto the moving media. The controller 120 is operatively connected to the color units 21A-21D through control lines 22. Each of the color units 21A-21D include a plurality of printheads positioned in a staggered arrangement in the cross-process direction over the media web 152. In some embodiments at least one of the color units 21A-21D ejects drops of material onto the surface of the media web 152. In some embodiments, multiple color units eject the material to form thicker layers of the material in the printed arrangements formed on the surface of the media web 152. In some embodiments, one or more of the color units 21A-21D eject drops of ink or other marking agents that form printed text and graphics on the surface of the media web in addition to the arrangements of the material that form structures within the material of the media web 152.

During operation, the controller 120 of the printer receives velocity data from encoders mounted proximately to rollers positioned on either side of the portion of the path opposite the four printheads to compute the position of the web as moves past the printheads. The controller 120 uses these data to generate timing signals for actuating the inkjets in the printheads to enable the color units 21A-21D to eject drops of the material onto the first and second sides of the media web 152 with a reliable degree of accuracy to form structures within the media web. The inkjets actuated by the firing signals correspond to image data processed by the controller 120. The image data can be transmitted to the printer, generated by a scanner (not shown) that is a component of the printer, or otherwise electronically or optically generated and delivered to the printer. In various alternative embodiments, the printer 5 includes a different number of color units.

Associated with each of color units 21A-21D is a corresponding backing member 24A-24D, respectively. The backing members 24A-24D are typically in the form of a bar or roll, which is arranged substantially opposite the printhead on the back side of the media. Each backing member is used to position the media at a predetermined distance from the printhead opposite the backing member. In the embodiment of FIG. 2, each backing member includes a heater that emits thermal energy to heat the media to a predetermined temperature which, in one practical embodiment, is in a range of about 40° C. to about 60° C. The various backer members can be controlled individually or collectively. The pre-heater 18, the printheads, backing members 24 (if heated), as well as the surrounding air combine to maintain the media along the portion of the path opposite the printing station 20 in a predetermined temperature range of about 40° C. to 70° C.

As the partially-imaged media web 152 moves to receive inks of various colors from the printheads of the print zone 20, the printer 5 maintains the temperature of the media web within a given range. The printheads in the color units 21A-21D eject the material at a temperature typically significantly higher than the temperature of the media web 152. Consequently, the ink heats the media. Therefore, other temperature regulating devices may be employed to maintain the media temperature within a predetermined range. For example, the air temperature and air flow rate behind and in front of the media may also impact the media temperature. Accordingly, air blowers or fans can be utilized to facilitate control of the media temperature. Thus, the printer 5 maintains the temperature of the media web 152 within an appropriate range for the jetting of all inks from the printheads of the print zone 20. Temperature sensors (not shown) can be positioned along this portion of the media path to enable regulation of the media temperature.

In the printer 5, the media transport moves the media web 152 through the print zone 20 two times for first and second side printing. The web inverter 84 flips the media web 152 after the first pass through the print zone 20 and the media transport returns the media web 152 to the print zone 20 with the second side facing the printheads in the color units 21A-21D for second side printing. FIG. 3 depicts a schematic view of a portion of the media path in the printer 5. In FIG. 3, the tandem duplex configuration of the print zone 20 includes the first side of the media web 152A that passes a first set of printheads in each of the color units 21A-21D. The first set of printheads includes a plurality of inkjets that form the arrangements of material in predetermined patterns on the first side of the media web 152. The web inverter unit 84 flips the media web 152 and the media transport returns the second side 152B to the print zone 20 for a second set of the printheads in the color units 21A-21D to form the arrangements of the material on the second side of the media web 152. In the configuration of FIG. 3, the first set of printheads that print on the first side 152A form the first print zone and the second set of printheads that print on the second side 152B form the second print zone.

After moving through the in-line air bearing heater 190 and/or convection heater 112, the media transport moves the media web 152 between cooling rolls 33 and to a rewind unit 90. The cooling rolls 33 are, for example, two metal rolls that maintain a uniform temperature as the media web 152 moves in the process direction. The cooling rolls 33 extract heat from the media web 152 and material in the media web 152 to cool and solidify the material into durable structures that penetrate through the thickness of the material in the media web 152. The rewind unit 90 includes a spool or other suitable device to return the continuous media web 152 to a spooled form after the printer 5 has formed the material structures in the media web 152. The spooled media web is removed from the printer 5 and sent for further processing, such as cutting the large roll of paper into smaller sheets incorporating one or more chemical assay devices that include the structures that are formed in the printer 5.

Following the print zone 20 along the media path, the media web 152 moves to the convection heater 112. In configuration of FIG. 2, the convection heater only receives the media web 152 after the media web 152 has passed through the print zone 20 for a second time for second-side printing. The convection heater 112 is a two-sided convection heater that operates in the same manner described above with regards to FIG. 1. In the printer 5, the convection heater 112 heats the air around the media web 152 to a temperature in a range from approximately 180° C. to 200° and the fans in the convection heater 112 circulate the heated air in a range from approximately 300 cubic meters per minute to 3120 cubic meters per minute. The media transport in the printer 5 moves the media web 152 at a rate of approximately 1.65 meters per second, and the convection heater 112 is configured with a length of approximately 1.6 meters along the process direction P to provide a dwell time of slightly less than one second in the convection heater 112. The convection heater 112 melts the material in the first-side and second-side printed arrangements to enable the material to penetrate the media web 152 from both sides and form structures that extend through the entire thickness of the media web 152.

Operation and control of the various subsystems, components and functions of the printer 5 are performed with the aid of the controller 120. The controller 120 is implemented with general or specialized programmable processors that execute programmed instructions. The memory 52 stores instructions code 62 containing the instructions required to perform the programmed functions. The controller 120 executes stored program instructions 62 in the memory 52 to form printed patterns on the media web 152 with reference to image data 64 that correspond to the first-side and second-side printed arrangements of the material. The controller 120 operates the printheads and corresponding inkjets in the color units 21A-21D to form printed arrangements of the material on the media web 152 with reference to the image data 64. The controller 120 is operatively connected to the memory 52. The memory 52 includes volatile data storage devices such as random access memory (RAM) and non-volatile data storage devices including magnetic and optical disks or solid state storage devices. The processors, their memories, and interface circuitry configure the controllers and/or print engine to perform the functions, such as the difference minimization function, described above. These components are provided on a printed circuit card or provided as a circuit in an application specific integrated circuit (ASIC). In one embodiment, each of the circuits is implemented with a separate processor device. Alternatively, the circuits can be implemented with discrete components or circuits provided in VLSI circuits. Also, the circuits described herein can be implemented with a combination of processors, ASICs, discrete components, or VLSI circuits.

FIG. 3 shows an isometric view of an in-line air bearing heater in accordance to an embodiment.

FIG. 3 illustrates part of the turnbar like cylinder 160 where a plurality of apertures are formed at the surface, a blower like blower 181 directs the forced air from the internal cavity to the surface of the cylinder where the forced air escapes. As the recording media 152 moves across the turnbar, a cushion of air, or an air bearing, is formed between the surface of the cylinder and the surface of the media facing the apertures on the cylinder surface. The air directed through the apertures of the turnbar provides a lifting pressure to separate the recording media from the surface of the turnbar during movement P. The lifting force created by the apertures depends on the air pressure provided by the blower, the area outer perimeter of the turnbar in contact with the paper, and the number and location of apertures formed in the surface of the turnbar through which the forced air escapes.

As can be seen from FIG. 3, air bearing 370 is provided with leading edge 330 and trailing edge 325 along first surface 350 on the turnbar or cylinder in the in-line air bearing heater 190. A recording media 152 such as a web material approaches air bearing 370 along first surface 350. Air 305 is provided along cylinder roll such as cylinder 160 to form air bearing 370 through hollow portion of the cylinder and is contained within internal region and escaping only through air bearing 370. Air 305 contained within internal region of the cylinder is then provided with sufficient pressure to enable air to exit air bearing 370 through aperture 316 at first surface 350 to create what is known as an air bearing where the media material can ride in a process direction. As recording media 152 approaches air bearing 370, boundary layer air proximate to the media is directed aerodynamically and fluidly past leading edge 330 to contact with a surface at the recording media.

If recording media 152 like a web material is provided with a machine direction tension, the migration of air 305 into the media like web material proximate to air bearing 370 along the first surface 350 can be coincident with the movement of web material 152 past first surface 350 of air bearing 370. Therefore, air 305 should remain proximate to web material 152 for the distance that web material 152 traverses from leading edge 330 to trailing edge 325 of air bearing 370. A higher speed web material 152 may require air bearing 370 to have an increased pressure in order to provide for adequate residence time for air 305 to remain proximate to air bearing 370.

In order to increase the efficiency of the air foil or air bearing, it may be desirable to provide a shallow depression around each of the plurality of supply openings 316. This increases the lifting force should recording media 152 try to block any of the supply openings 316, and is standard practice in air bearing design. Such an opening pattern 310 is shown in FIG. 3. Each supply opening 316 is surrounded by a shallow depression 319. In other embodiments of the inventions, supply openings 316 can be replaced by pads comprising a porous material such as porous graphite or sintered metal. As illustrated in FIG. 3, second surface portion 320 of the cylinder is devoid of openings and an air bearing is not created in this region.

The density of the apertures 316 within the first surface 350, in part, determines the amount of an air foil or a float provided between the surface of the cylinder at the first surface 350 and the recording media such as a continuous web. If the continuous web of print media does not float above the surface of the cylinder, but instead contacts the first surface 350, a tangent line is defined on the turnbar cylinder along a leading edge 330 and a trailing edge of the recording media.

The predetermined pattern 310 forming the air bearing 370 is defined to include at least one row of apertures after the leading edge 330 and at least one row of apertures located before the trailing edge 325. In the illustrated embodiments, a row of apertures is provided at the leading edge and trailing edge of the air bearing 370. A row of apertures need not be provided at both the leading edge and trailing edge. In other embodiments, one or both of the rows of apertures include a size different than the remaining apertures in the pattern 310 at the first surface 350. In still another embodiment, the number of apertures of the leading and trailing edge rows are different than the rows of apertures in the remaining pattern at the first surface 350.

As the continuous web moves across the surface of the turnbar, like at cylinder 160, a row of apertures 316 above a surface defined between the tangent lines provides a float or an air cushion. Outside the defined surface the pressure under the web returns to atmosphere. The row of apertures like 316 can be spaced between the tangent lines (330, 325) equal distanced when the rows are evenly spaced in the aperture pattern 310. Additionally by placing at least one row of apertures before the leading edge tangent line 330 and at least one row of apertures after the trailing edge tangent line 325, air pressure turbulence between the tangents is reduced or prevented. In one embodiment, the first and last row of holes are biased approximately X degrees before the incoming web tangent line and X degrees after the tangent line at the web exit. By locating the first and last row of apertures outside the tangent lines, eddy current cancelation is provided to aid in floating the web at the tangents. In another embodiment, the first and last rows of apertures are placed at the tangent lines, but include apertures of a different size that the remaining apertures of the pattern. The plurality of apertures should define a pattern 310 that includes a plurality of rows and a plurality of columns, each of the rows being aligned in a longitudinal direction along a length of the turnbar or roll lie cylinder 160, one of a first row of apertures and a last row of apertures being disposed outside of the contacting area.

The first and last rows of apertures and the first and last columns of apertures define a perimeter where the first and last columns substantially coincide with the outer edges of the recording media of the largest size of media being imaged. The first and last columns generally coincide with the outer edges of the width of the recording media. In one embodiment, the apertures within the perimeter defined by the pattern 350 are spaced evenly along the rows and along the columns such that no portion of the pattern within the perimeter is missing apertures.

Without desiring to be bound by theory, it is believed that increasing the residence time that air 305 is proximate to recording media 152 provides for an increased impingement of air 305 upon the media like a an air bearing for supporting the media without physical contact to the turnbar, but the heat can be transferred to the media to raise the temperature, to facilitate in drying, or to facilitate leveling of surface coatings through shear stresses between the static cylinder (160, 161, 162) and media like a moving web.

FIG. 4 illustrates a single in-line air bearing heater and convection oven useful for transporting and contactless heating of a recording media in accordance to an embodiment.

Next, another embodiment of the present invention will be described. Note that portions which are the same as those in the first embodiment described above are denoted by the same reference numerals, and descriptions of the same portions as those as in the first embodiment will be omitted.

FIG. 4 illustrates a view of one of the turnbars, such as turnbar 160, with a predetermined sized imaging web media 152, such as paper, partially wrapped about an exterior surface of the turnbar. Turnbar 160 spans the width of the moving web so as to provide a lifting force. While the turnbar 160 is illustrated, in one embodiment the other turnbar like 162 is similarly configured. The exterior surface includes an air region 410 having a plurality of apertures which extend from an interior cavity of the turnbar, through a sidewall of the turnbar, and through the surface to provide airflow like air bearing 370 from the interior to the exterior of the turnbar. The pattern of apertures which defines the air region 410 includes a non-aperture portion located within a perimeter border of apertures including one or more rows of apertures and one or more columns of apertures. A region of a non-aperture surface 420 is disposed outside the pattern and so does not define an air region. The turnbar may include a mechanism to cause rotation 430 of the turnbar to change the contacting area at the recording media 152 by a predetermined number of degrees.

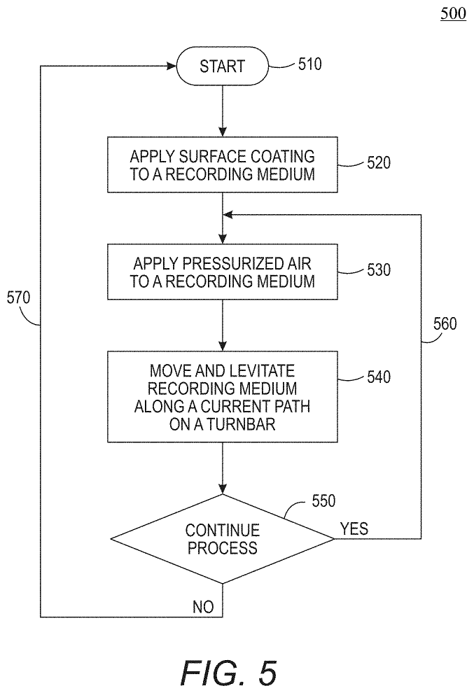

FIG. 5 is a flowchart depicting the operation of an exemplary method for in-line contactless heating of a print media in accordance to an environment.

Interconnection between the processes represents the exchange of information between the processes. Once the flow is modelled, each process may be implemented in a conventional manner. Each process may, for example, be programmed using a higher level language like Java, C++, Python, Perl, or the like, or may be performed using existing applications having a defined interface. For example, the function of certain processes may be provided by remote web servers using conventional web interfaces like CGI scripts or the like. As well, flow programming allows individual process to execute on different hardware and software platforms, or through the actions of an operator where possible, that may physically remote from each other. Upon execution, a run-time environment (including run-time code) acts as a flow engine and ensures co-operation between processes in accordance with the flow model. The run-time code typically looks after process execution; inter-process communication; errors; system crashes and the like. Conveniently, programmers and architects need not be concerned about these details as they are handled by run time code.

Method 500 begins with action 510 such as by powering the imaging system or by the starting of a process event such as print. Control is then passed to action 520 where the recording media is applied with surface coating to form an image on the recording media such as a web.

In action 530, pressurized air is applied to the recording medium through the apertures of the turnbar as described above with reference to FIGS. 1-4. The result of applying air to the media causes action 540 where the recording media is raised or levitated and moved by the air from the turnbar. In action 550, a determination is made to continue process 500. In case where it is decided to continue the process (YES) 560 then actions 530 and 530 are repeated. In case where it is decided not to continue the process (NO) 570 the process is send to start or action 510 where the method 500 waits for a signal to begin the process.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

What is claimed is:

1. An apparatus useful in processing a recording media moving along a path in an imaging system, comprising:
a print zone including a first plurality of marking material deposition sources configured to facilitate surface coatings on a side of the recording media;
a blower configured to provide a flow of pressurized air;
at least one turnbar with at least one aperture disposed thereon to provide, from the flow of pressurized air, an air bearing having a leading edge and a trailing edge;
wherein the turnbar defines a first tangent line corresponding to an initial point of contact of the recording media and the turnbar in the absence of the air bearing, a second tangent line corresponding to a last point of contact of the recording media with the turnbar in the absence of the air bearing, and a contacting area disposed between the first tangent line and the second tangent line in the absence of the air bearing;
wherein the turnbar having an exterior surface defining a first region and a second region, which is substantially devoid of apertures, the first region having the at least one aperture operatively connected to the blower, the at least one aperture defining a pattern aligned in a longitudinal direction along a length of the turnbar, the at least one aperture being configured to direct the pressurized air from the exterior surface of the turnbar, and the pressurized air through the second region is not directed from the exterior surface.

2. The apparatus in accordance to claim 1, wherein the pressurized air is selected from the group consisting of heated air, gas, vapor, superheated steam, and combination thereof.

3. The apparatus in accordance to claim 2, wherein heat from the pressurized air can be transferred to the recording media to raise the temperature of the recording media, to facilitate drying, or to facilitate leveling of the surface coatings.

4. The apparatus in accordance to claim 2, wherein the at least one aperture comprises a plurality of apertures selected from the group consisting of holes, slots, slits, and combinations thereof.

5. The apparatus in accordance to claim 4, wherein the plurality of apertures defining a pattern including a plurality of rows and a plurality of columns, each of the rows being aligned in a longitudinal direction along a length of the turnbar, one of a first row of apertures and a last row of apertures being disposed outside of the contacting area.

6. The apparatus in accordance to claim 5, wherein the plurality of columns includes a first column and a last column and at least one of the plurality of columns is disposed outside of the contacting area.

7. The apparatus in accordance to claim 5, wherein the at least one turnbar is a cylinder made from a material selected from the group consisting of metal, aluminum, plastic having melting point higher than 200° C., and combinations thereof.

8. The apparatus in accordance to claim 7, wherein the exterior surface can rotate.

9. The apparatus in accordance to claim 8, the apparatus further comprising:
a heater to direct heat onto a portion of the at least one turnbar to heat the pressurized air.

10. The apparatus in accordance to claim 2, wherein the flow of pressurized air prevents the recording media from contacting the at least one turnbar at the exterior surface defining a first region;
wherein the recording media is a web of material.

11. A method for heating a recording media moving along a path in an imaging system, comprising:
applying surface coatings on a side of the recording media;
providing a flow of pressurized air;
providing at least one turnbar with at least one aperture disposed thereon to provide, from the flow of pressurized air, an air bearing having a leading edge and a trailing edge;
wherein the turnbar defines a first tangent line corresponding to an initial point of contact of the recording media and the turnbar in the absence of the air bearing, a second tangent line corresponding to a last point of contact of the recording media with the turnbar in the absence of the air bearing, and a contacting area disposed between the first tangent line and the second tangent line in the absence of the air bearing;
wherein the turnbar having an exterior surface defining a first region and a second region, which is substantially devoid of apertures, the first region having the at least one aperture operatively connected to a blower, the at least one aperture defining a pattern aligned in a longitudinal direction along a length of the turnbar, the at least one aperture being configured to direct the pressurized air from the exterior surface of the turnbar, and the pressurized air through the second region is not directed from the exterior surface;
moving the recording media along a substantially curved path, wherein the substantially curved path is adjacent to the first region of the at least one turnbar;
bending the recording media as it is moves along the substantially curved path and preventing by application of the pressurized air the recording media from contacting the first curved surface.

12. The method in accordance to claim 11, wherein the pressurized air is selected from the group consisting of heated air, gas, vapor, superheated steam, and combination thereof.

13. The method in accordance to claim 12, wherein the exterior surface can be rotating.

14. The method in accordance to claim 12, wherein heat from the pressurized air can be transferred to the recording media to raise the temperature of the recording media, to facilitate drying, or to facilitate leveling of the surface coatings.

15. The method in accordance to claim 13, wherein the at least one aperture comprises a plurality of apertures selected from the group consisting of holes, slots, slits, and combinations thereof.

16. The method in accordance to claim 15, wherein the plurality of apertures defining a pattern including a plurality of rows and a plurality of columns, each of the rows being aligned in a longitudinal direction along a length of the turnbar, one of a first row of apertures and a last row of apertures being disposed outside of the contacting area.

17. The method in accordance to claim 16, wherein the plurality of columns includes a first column and a last column and at least one of the plurality of columns is disposed outside of the contacting area.

18. The method in accordance to claim 15, wherein the at least one turnbar is a cylinder made from a material selected from the group consisting of metal, aluminum, plastic having melting point higher than 200° C., and combinations thereof.

19. The method in accordance to claim 18, the method further comprising:
heating a portion of the at least one turnbar to heat the pressurized air.

20. The method in accordance to claim 12, wherein the flow of pressurized air prevents the recording media from contacting the at least one turnbar at the exterior surface defining a first region;
wherein the recording media is a web of material.
